(19) United States
(12) Patent Application Publication
(10) Pub. No.: US 2012/0274262 A1
(43) Pub. Date: Nov. 1, 2012

(54) VOLTAGE AND SPEED SENSITIVE MOTOR CONTROL STARTING CIRCUIT

(76) Inventor: John F. Parrish, Decatur, IN (US)

(21) Appl. No.: 13/402,849

(22) Filed: Feb. 22, 2012

Related U.S. Application Data
(60) Provisional application No. 61/480,821, filed on Apr. 29, 2011.

(51) Int. Cl. H02P 1/44

(52) U.S. Cl. 318/786

(57) ABSTRACT

A voltage and speed sensitive solid state motor control starting circuit is a RPM voltage sensing circuit for controlling the starting circuit operation of an AC induction motor. The circuit effectively removes the start capacitor from the AC circuit at a predetermined RPM cutout voltage and reengages the start capacitor at a predetermined cut in voltage. The circuit may be installed on an AC induction motor to replace conventional mechanical switches that are used for removing start capacitors from the AC induction motor circuit. The circuit is more simplified and less complex than conventional mechanical switches, while being very efficient.

### CROSS-REFERENCE TO RELATED APPLICATIONS

This application claims the benefit of priority of U.S. provisional patent application No. 61/480,821, filed Apr. 29, 2011, the contents of which are herein incorporated by reference.

### BACKGROUND OF THE INVENTION

The present invention relates to motor control starting circuits and, more particularly, to a cost effective, voltage and speed sensitive solid state motor control starting circuit.

Mechanical switches are used in single phase motors to remove the starting capacitors and/or the starting winding after the motor has reached the desired threshold of speed that is required for the motor to function correctly. Mechanical switches in electric motors create several problems. Mechanical switches become worn out, typically very quickly, due to the fact that they have moving parts. Mechanical switches also have electrical contacts that ark on every motor start up and also when stopping.

As can be seen, there is a need for an improved motor control starting circuit that does not rely upon mechanical switches to remove starting capacitors and/or the starting winding.

### SUMMARY OF THE INVENTION

In one aspect of the present invention, a solid state motor control starting circuit comprises a rectifier for converting AC power from an AC power supply to DC rectified power; a thyristor connecting a starting capacitor and a start winding of an AC induction motor to the AC power supply upon conduction thereof; an optocoupler triac driver adapted to trigger the thyristor into conduction; a voltage divider network adapted to sense the rpm and cut out voltage of the start winding; and a silicon controlled rectifier adapted to be triggered into conduction when the voltage divider network detects a threshold speed or generated voltage, the silicon controlled rectifier turning off the thyristor upon conduction.

In another aspect of the present invention, a method for starting an AC induction motor comprises converting AC power from an AC power supply to DC rectified power; connecting a starting capacitor and a start winding of the AC induction motor to the AC power supply upon conduction of a thyristor; triggering the thyristor into conduction with an optocoupler triac driver; sensing the rpm and cut out voltage of the start winding with a voltage divider network; and triggering a silicon controlled rectifier into conduction when the voltage divider network detects a threshold speed or generated voltage, the silicon controlled rectifier turning off the thyristor upon conduction.

These and other features, aspects and advantages of the present invention will become better understood with reference to the following drawings, description and claims.

### BRIEF DESCRIPTION OF THE DRAWINGS

FIG. 1 is a circuit diagram showing an induction motor connected to a solid state motor control starting circuit according to an exemplary embodiment of the present invention; and

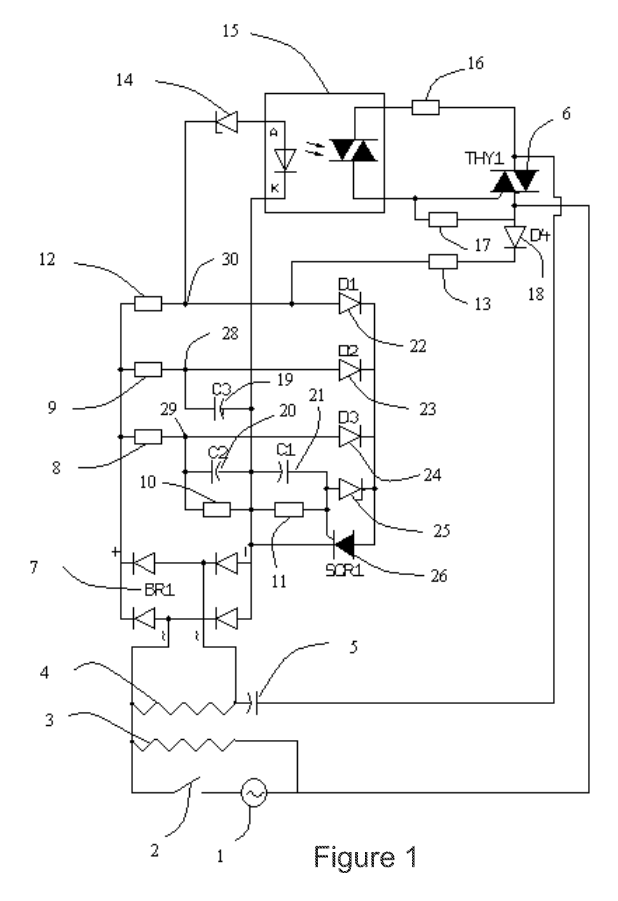

FIG. 2 is a graph showing a switch cut-out line on a graph of the percentage of motor start winding voltage at start-up vs. percentage of motor rpm at start-up.

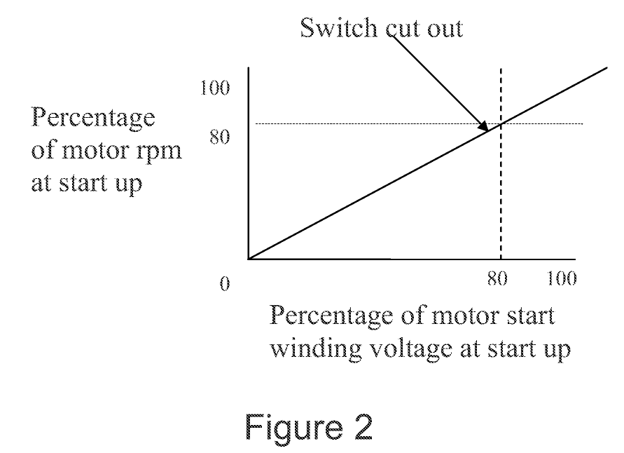

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a voltage and speed sensitive solid state motor control starting circuit. The circuit is a RPM voltage sensing circuit for controlling the starting circuit operation of an AC induction motor. The circuit effectively removes the start capacitor from the AC circuit at a predetermined RPM cutout voltage and reengages the start capacitor at a predetermined cut in voltage. The circuit may be installed on an AC induction motor to replace conventional mechanical switches that are used for removing start capacitors from the AC induction motor circuit. The circuit of the present invention may be more simplified and less complex than conventional mechanical switches, while being very efficient.

Referring now to the Figure, the circuit of present invention may connect to an AC induction motor having a main winding 3, a start winding 4 and a start capacitor 5. The motor may be powered by an AC power supply 1, the power from which may be regulated by a switch 4.

The elements of the circuit are described briefly below and will be described in greater detail in the paragraphs to follow. The circuit of the present invention may include a solid state thyristor 6 (also referred to as triac 6) for controlling the start capacitor 5 and start winding 4. A bridge rectifier 7 may be used to convert AC power to DC rectified power. Resistor 8 may be part of a resistor network for sensing voltage and rpm generated by the start winding 4. Resistor 9 may be part of a resistor capacitor timing network. Resistor 10 may be part of a resistor network for sensing voltage and rpm generated by the starting winding 4. Resistor 11 may be used to control the sensitivity of a silicon controlled rectifier (SCR) 26. Resistor 12 may supply rectified power to optocoupler triac driver 15. Resistor 13 may supply rectified power to optocoupler triac driver 15. Diode 14 may be used to regulate voltage to optocoupler triac driver 15. Optocoupler triac driver 15 may provide on-off control for triac 6. Resistor 16 may be used to limit current to the gate of triac 6. Resistor 17 may be used to control the sensitivity of triac 6. Diode 18 may be used to change AC power to DC rectified power. Capacitor 19 may be part of a timing circuit with resistor 9, at node 28. Capacitor 20 may be used for filtering DC rectified power across a resistor network at node 29. Capacitor 21 may be used to filter DC rectified power that is supplied to the gate of SCR 26. Capacitor 21 may be used to prevent regenerative effects of the start winding 4 upon induction motor turn off. Diodes 22, 23, 24 may be used to prevent reverse DC voltages to SCR 26. Voltage type diode 25 may be used to trigger the SCR 26 into conduction. The SCR 26 may be used to control the optocoupler triac driver 15.

Various substitutions may be within the scope of the present invention. For example, if triac 6 is snubberless, then resistor 17 may not be necessary. Furthermore, triac 6 can be substituted by inverse SCR's and more than one optocoupler triac driver 15 may be used for high voltage applications. Also, the resistor 11 may not be necessary depending on the sensitivity of the SCR 26. In some embodiments, extra resistors may be added in parallel with another resistor to increase current requirements for another part of the circuit.

The Figure is a circuit diagram only, and one embodiment implementing this circuit (such as a solid state electric motor starting switch) may include these components located differently with respect to each other, even though the electrical configuration may be the same.

As shown in the Figure, the power supply 1, connected through the off-on switch 2, can provide power to an induction motor that includes the main winding 3, starting winding 4 and starting capacitor 5. The circuit of the present invention is an RPM Voltage sensing circuit for controlling the starting circuit operation of the AC Induction Motor. The invention circuit effectively removes the starting capacitor from the AC circuit at the predetermined rpm cutout voltage and reengages the starting capacitor at the predetermined cut in voltage. When the switch 2 is turned on, power is supplied to the induction motor main winding 3, circuit of the present invention (which includes elements 6-30, starting winding 4, and starting capacitor 5.

Bridge rectifier 7 and diode 4 change AC power to DC in the circuit of the present invention. DC power is supplied to optocoupler triac driver 15 through resistors 12, 13. Optocoupler triac driver 15 triggers triac 6 into conduction, causing starting capacitor 5 and starting winding 4 to connect to the AC power supply 1. Resistor 17 is a bias resistor for the triac 6. Start winding 4 and starting capacitor 5 causes a phase shift between main winding 3 and start winding 4, causing the AC induction to start.

Resisters 8, 10 and capacitor 20 form a voltage divider network for sensing the RPM and cut out voltage of start winding 4. The generated positive voltage detected at node 29 is directed through diode 24. When the positive voltage at diode 24 reaches the magnitude, or voltage rating of voltage diode 25, SCR 26 is triggered into conduction. SCR 26 effectively turns off optocoupler triac driver 15 by tuning off positive voltage at diode 22 from node 30. Optocoupler triac driver 15 then turns off triac 6, effectively removing starting capacitor 5 from the AC circuit 1. Resistor 9 and capacitor 19 form a resistor capacitor timing network. Positive voltage at node 28 is directed through diode 23. When positive voltage at diode 25 reaches the voltage rating of voltage diode 25, SCR 26 is triggered into conduction. This timing circuit is a safety triggering circuit in case the start winding 4 does not generate the correct voltages due to a defective starting capacitor 5 or other unforeseen defects.

Capacitors 19, 20 provide a filtered DC voltage for SCR 26. SCR 26 can stay into conduction once triggered into its on state until the SCR 26 holding current drops below its rating. The sensitivity of SCR 26 can determine the cut in voltage for the start capacitor 5. The sensitivity of SCR 26 can be adjusted by resister 11. Capacitor 21 also provides DC filtering for SCR 26 and also prevents start winding 4 regenerative effects upon AC induction motor turn off.

An electronic circuit board could be designed for all the electronic components of the invention, where the components could be connected according to the Figure.

Embodiments of the present invention could be installed on an AC induction motor to replace the mechanical switches that are used for starting the AC induction motor.

To connect the circuit of the present invention to the AC induction motor, for example, the terminals or wires from the circuit of the present invention could either be numbered or letter labeled with a wiring schematic.

It should be understood, of course, that the foregoing relates to exemplary embodiments of the invention and that modifications may be made without departing from the spirit and scope of the invention as set forth in the following claims.

What is claimed is:

1. A solid state motor control starting circuit comprising:
a rectifier for converting AC power from an AC power supply to DC rectified power;
a thyristor connecting a starting capacitor and a start winding of an AC induction motor to the AC power supply upon conduction thereof;
an optocoupler triac driver adapted to trigger the thyristor into conduction;
a voltage divider network adapted to sense the rpm and cut out voltage of the start winding; and
a silicon controlled rectifier adapted to be triggered into conduction when the voltage divider network detects a threshold speed or generated voltage, the silicon controlled rectifier turning off the thyristor upon conduction.

2. The solid state motor control starting circuit further comprising a timing network adapted to trigger the silicon controlled rectifier into conduction without sensing normal voltage magnitude of the start winding.

3. The solid state motor control starting circuit further comprising a resistor for controlling sensitivity of the silicon controlled rectifier.

4. The solid state motor control starting circuit further comprising a resistor for controlling sensitivity of the thyristor.

5. The solid state motor control starting circuit of claim 1, wherein the rectifier is a bridge rectifier.

6. The solid state motor control starting circuit of claim 1, further comprising a capacitor adapted to filter DC rectified power supplied to a gate of the silicon controlled rectifier and to prevent regenerative effects of the start winding upon turn of off the motor.

7. A method for starting an AC induction motor, comprising:
converting AC power from an AC power supply to DC rectified power;
connecting a starting capacitor and a start winding of the AC induction motor to the AC power supply upon conduction of a thyristor;
triggering the thyristor into conduction with an optocoupler triac driver
sensing the rpm and cut out voltage of the start winding with a voltage divider network; and
triggering a silicon controlled rectifier into conduction when the voltage divider network detects a threshold speed or generated voltage, the silicon controlled rectifier turning off the thyristor upon conduction.

8. The method of claim 7, further comprising triggering the silicon controlled rectifier into conduction with a timing network, without sensing normal voltage magnitude of the start winding.

9. The method of claim 7, further comprising filtering DC rectified power supplied to a gate of the silicon controlled rectifier and preventing regenerative effects of the start winding upon turn of off the motor.

10. The method of claim 7, further comprising controlling sensitivity of the silicon controlled rectifier and the thyristor with one or more resistors.
